(19) United States
(12) Patent Application Publication
(10) Pub. No.: US 2008/0065736 A1
(43) Pub. Date: Mar. 13, 2008

(54) SYSTEM AND METHOD FOR MANAGING EMAILS BASED ON USER RESPONSE TIME

(76) Inventor: William Gross, Pasadena, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/853,757

(22) Filed: Sep. 11, 2007

Related U.S. Application Data
(60) Provisional application No. 60/844,200, filed on Sep. 12, 2006.

(51) Int. Cl. G06F 15/16

(52) U.S. Cl. 709/207

(57) ABSTRACT

An email management method including the steps of determining a user response interval for a plurality of emails, generating an attribute priority number for one or more attributes associated with the plurality of emails, and automatically ranking new emails based on the attribute priority numbers associated with the first plurality of emails. The attribute priority numbers may, therefore, be used to infer the relevance of new emails based on the recipient's response time and then display those new emails from the most relevant to least relevant. In the preferred embodiment, the primary email attribute upon which emails are automatically ranked is the sender's name or identity, although various other properties of an email may be used to determine a suitable display order for new emails.

### PRIORITY APPLICATIONS

This application claims the benefit of U.S. Provisional Patent Application 60/844,200 (filed 12 Sep. 2006) which is hereby expressly incorporated by reference herein.

### FIELD OF THE INVENTION

The present invention relates to email management tools and more specifically a system and method for managing emails (electronic mail messages) based on user response time or relative user response time.

### BACKGROUND OF THE INVENTION

Email has dramatically changed the manner in which we receive information, and quantity of information we receive. Because of the ease with which email can be sent, many users find themselves inundated with email messages. This can be especially troublesome if a recipient spends meaningful time without email access. The problem is compounded because a user has to sort though messages having little or no relevance to the recipient (as with a bulk email solicitation). Finally, even relevant emails are often addressed based on a sense of real or perceived urgency. Thus, a user may have to wade through a significant number of unimportant or less important messages in order to discover the most important messages, which may require immediate responses.

Therefore, there is a need for a system that helps the user to distinguish between email messages that require a timely response from those emails that are less urgent or do not require any response at all.

### SUMMARY OF THE INVENTION

The present invention features a system and method configured to sort messages based on the user's prior response time, thereby allowing the user to rapidly identify and respond to messages that are most important without regard to date or time those messages were received by the user.

One embodiment of the present invention provides an email management tool. The tool includes a display area for displaying a list of received emails, wherein a plurality of the received emails are sorted based upon priority metrics associated with the senders of the plurality of emails. In some cases the priority metrics comprise average user response times. In some cases the average response times are based on the average time elapsed between receipt of one or more preceding emails and transmission of a response to the one or more preceding emails by the user.

In another embodiment the present invention provides an email management apparatus including a perceptible user interface. In most cases this could be a display screen, emitting or reflecting electromagnetic radiation in the visible region (400-700 nm). However it may be desirable to rely on an audible interface (20-20,000 Hz), as might be the case with a cellular phone or even a conventional computer system adapted for the sight impaired. The embodiment further includes an email response interval capture component. The response interval capture component notes the interval of time elapsing between the time that the email is received and the time a response is set. In another embodiment receipt can also be the time between the email is opened. Opening emails out of sequence, that is skipping the first six emails in a queue to open the seventh might be an indicia that the reader considers the seventh email to have a higher priority. The embodiment also includes an email response interval storage component. This component stores the time for the email response or other indicia of user perceived importance. At least one display priority metric component uses collected user information and optionally external information (including specific features of the emails themselves) to prioritize the sequence. The email response interval capture component is configured to capture the interval between the time an email is received and the time the received email is responded to. The email response interval storage component stores the response interval and the at least one display priority metric component correlates the intervals from the interval storage component with certain characteristics of the email message and creates a display priority. As previously indicated, the email can be said to be received either when the email is opened, downloaded from a server, or other time.

In another embodiment the certain characteristics include at least two of the following: the sender of the email, the content of the message, the time of day that the message is sent, the subject of the message, the number of recipients of the email, the elapsed time between the time the message was sent and the time it was received, and sender included indicia of urgency. The sender included indicia of urgency may be a selection made by the sender, or words or expressions in the subject or body of a message.

In another embodiment the certain characteristics include at least one: the top level domain name of the sender of the email, the sentence structure of the message, the punctuation in the message, the occurrence of misused words in the message, the time the message is sent, the subject of the message, the number of recipients of the email, the status of the recipient, that is was the recipient a primary recipient, a copied recipient, a blind copied recipient, or otherwise designated as a non-primary or primary recipient. Other characteristics, may include the elapsed time between the time the message was sent and the time it was received, and sender included indicia of urgency. In another embodiment the email management apparatus includes at least one display priority metric component that dynamically updates a list of unread messages as new messages are received.

In another embodiment, the invention provides an email management method comprising the step of monitoring the interval between the time that a message is received and the time that a user responds to said message, identifying various properties of the message, correlating the various properties of the message with the monitored interval, and displaying email messages in a sequential order based on the various properties. The various properties of the message include at least two of the following: the sender of the email, the content of the message, the time of day that the message is sent, the subject of the message, the number of recipients of the email, the elapsed time between the time the message was sent and the time it was received, and some sender included indicia of urgency. Alternatively, the various properties could include at least one of the following: the domain of the sender of the message, the sentence structure of the message, punctuation in the message, misused words in the message, the time of the day when the message is sent, the subject of the message, the number of recipients of the email, the status of the recipient, the elapsed time between the time the message was sent and the time it was received, and a sender included indicia of urgency.

In another embodiment the status of the recipient is selected from at least of the following: to, carbon copy, and blind carbon copy. Further, the sender included indicia of urgency includes at least one of: an email editor provided option allowing a user to specify urgency, a term in the subject line indicating urgency, and one or more terms or expressions in the body which contextually indicate urgency.

In another embodiment an email management system is provided, said system comprising a learning module that identifies and stores user provided indicia of relative importance, an algorithm that utilizes the identified and stored user provided indicia of relative importance to create a dynamically variable email message display sequence based on output from said algorithm. The system optionally includes a means for obtaining user provided indicia of relative importance including: the interval between the time a message is received and the time a message is responded to, the likelihood that a message will be read out of sequence, the frequency with which a message is not responded to, the interval of time a message is left open as function of the message length, message complexity, and message source. Further, the message sequence is altered based on, non-learned, user provided sequence customization instructions. In one embodiment the user provided sequence customization is based on the number of substantially contemporaneous messages having a predetermined level of overlap in content.

In another embodiment of the present invention an email management method is provided. The method includes the steps of determining a user response interval for a plurality of emails. In essence this could include determining the time that elapses between the time an email is received, viewed, or read and the time that the email is responded to. This interval is used as a starting point for generating a priority number with which new emails from the sender are ranked and displayed to the user. In some embodiments, the priority number used to characterize the priority of an email is based only on the sender name and the response interval derived from one or more previous emails from the user. In some other embodiments, the priority number is based on a plurality of attribute priority numbers associated with a plurality of email attributes. Each of the attributes of a single email may give rise to a different priority level characterized by an attribute priority number. That is, an email may possess a sender name associated with one priority number, the subject line give rise to a second priority number, the body of the email give rise to a third priority number, etc. In some embodiments, the individual attribute priority numbers are individually computed and combined (or reconciled) into an overall priority number using a weighted linear combination, for example. In another embodiment, the plurality of attribute priority numbers are collectively determined using maximum likelihood estimation technique, or by selecting the highest priority number of the plurality of priority numbers associated with the email. It is also contemplated that many other techniques could be used.

It is specifically contemplated that the attribute priority number will be updated on a periodic basis. The periodicity is may be varied based on number of emails received, a pre-selected period, a user specified period, a predetermined period, or upon an event, such as a hard shutdown, application closure, or a detected change in user preferences. This later portion could be based on opening emails out of turn in the displayed sequence, or a period of unusually high email traffic. If the period is based on a chronological displacement, the period could be as short as one second, or every time an email is received, to as much as 90 days or more. In many cases one day, two days, three days, four days five days six days, seven days, thirty days and 45 five days are especially preferred. A hybrid function of time and number of messages may also be used, this latter functionality would be most helpful in situations where email traffic flow is especially high (more than about 50 messages a day), especially low (fewer than about 20 messages a day), or where email traffic flow is irregular. Irregular may include situations where traffic flow, on business days varies by more than about 73%, based on total incoming messages, or where there is a transient spike in the number of outgoing messages. A spike may include changes in excess of about 15% based on the number expected for a comparable number of incoming messages.

### BRIEF DESCRIPTION OF THE DRAWINGS

The present invention is illustrated by way of example and not limitation in the figures of the accompanying drawings, and in which:

FIG. 1A is a network including at least one email management tool adapted to sort emails based on user response time, in accordance with the preferred embodiment of the present invention;

FIG. 1B is a message diagram showing the exchange of multiple emails between two users, in accordance with the preferred embodiment of the present invention;

FIG. 2 is the user interface of an email management tool for sorting emails based on user response time, in accordance with a first preferred embodiment of the present invention;

FIG. 3 is the user interface of an email management tool for reviewing higher-priority emails sorted based on user response time, in accordance with a second preferred embodiment of the present invention; and

FIG. 4 is the user interface of an email management tool for reviewing lower-priority emails sorted based on user response time, in accordance with the second preferred embodiment of the present invention.

### DETAILED DESCRIPTION OF THE PREFERRED EMBODIMENT

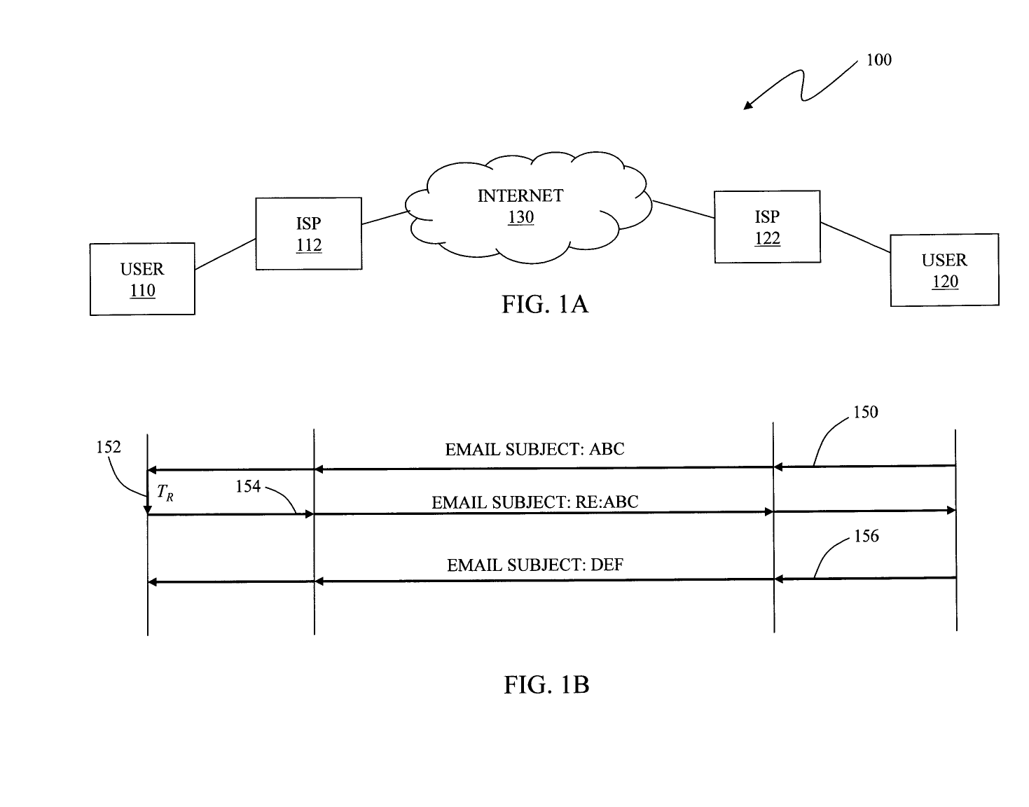

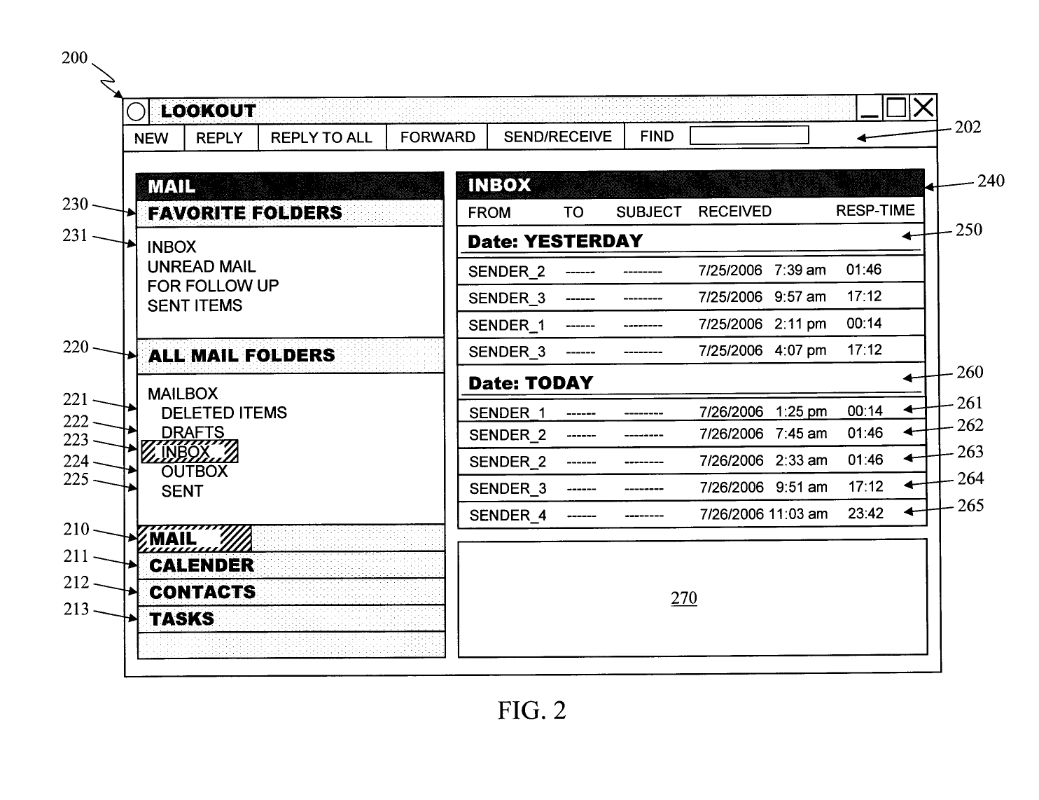

Illustrated in FIG. 1 are two of a plurality of users that are remotely connected via a data communications network through which the users can exchange email messages. The network in the preferred embodiment includes the Internet 130, a local area network, a wide area network, or a combination thereof. A plurality of users including a first user 110 and second user 120 are connected to the Internet 130 via respective Internet Service Providers (ISPs) 112, 122. The network 100 is configured to implement the various protocols including Ethernet and Internet Protocol (IP), for example, both of which are well understood by those skilled in the art. The users are adapted to exchange emails using an email program installed on one of a set of computing devices including personal computers, mobile phones, and personal digital assistants, for example. The email program is preferably an email management tool, i.e., an email client, adapted to generate, send, receive, and respond to emails using various protocols including Simple Mail Transfer Protocol (SMTP), Post Office Protocol 3 (POP3), HTTP Protocol, or a combination thereof.

In accordance with this exemplary embodiment, the first user's email management tool is adapted to sort and rank incoming emails from a plurality of senders based on priority metrics associated with the individuals or entities sending the emails. The priority metric associated with a sender is preferably based, at least in part, on the how quickly the email recipient responds to one or more emails from the sender. The metric is measured in terms of the average elapse time between receipt of an email from a particular sender and the time the recipient, i.e., the first user 110, responds to the email. Emails received from a sender to whom the user 110 regularly responds in a relatively short period of time are treated as a high priority, while emails received from a sender to whom the user 110 regularly responds in a relatively long period of time (or never) are treated as a low priority.

Illustrated in FIG. 1B is a message diagram showing a series of email exchanges between the first user 110 and second user 120. If the second user 120 transmits an email message 150, the first user 152 receives and reviews the email and, if applicable, generates an email response 154. The time between receipt of the first email 150 and response email 154 is referred to herein as the response time TR 152. An average response time associated with the second user may be dynamically generated based on all or some of the previous email exchanges between the first and second users. An average response time is preferably maintained by the first user's email management program for each individual sender or each email address from which an email is received.

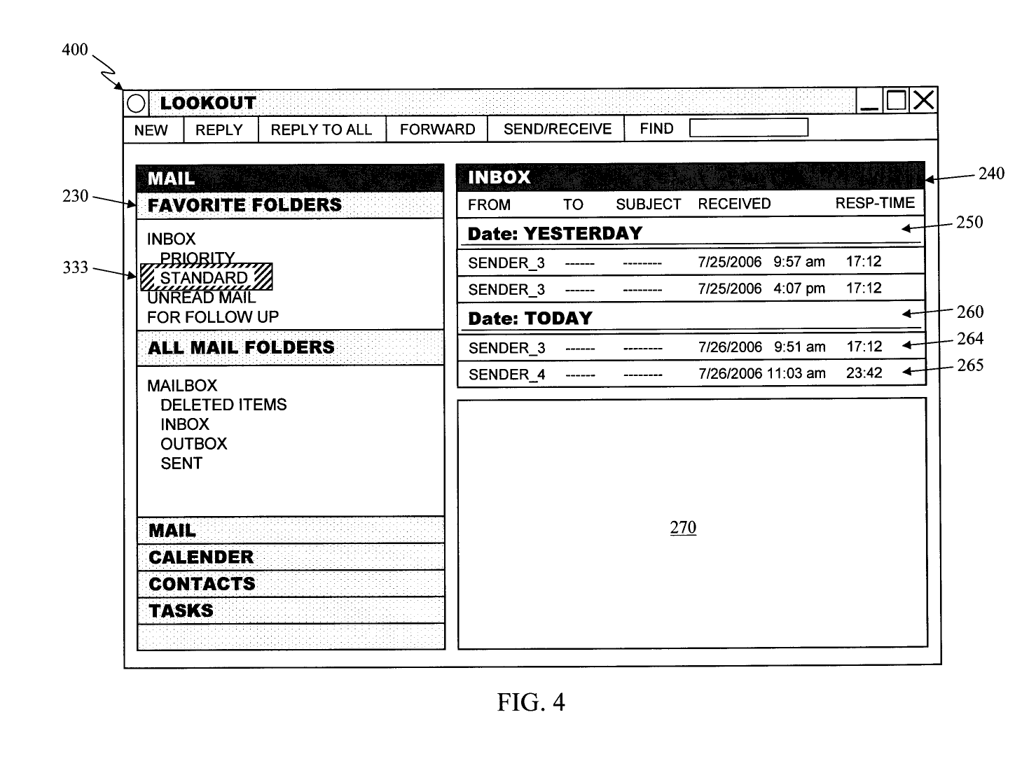

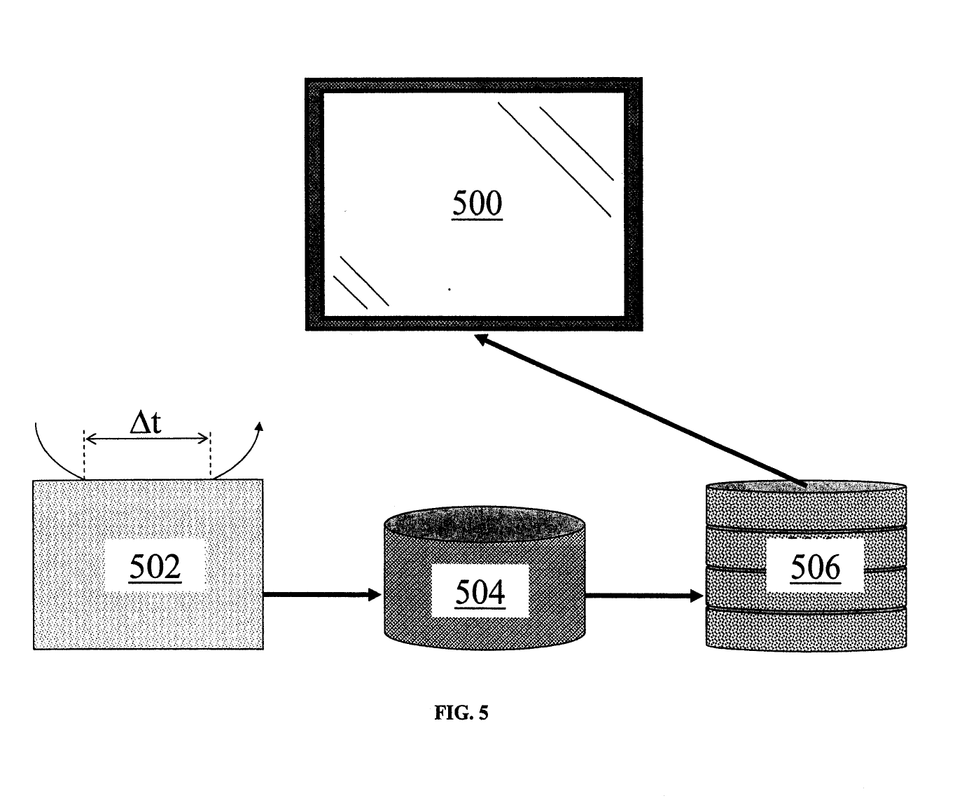

At one or more times during a typical day, the first user 110 retrieves from the ISP 112 a set of unread emails originating from a plurality of senders including a new email 156 from the second user 120. The first user's 110 email management tool identifies the various senders, retrieves the average response time associated with each of the senders including the second user 120, and determines the relative priority (i.e., rank) of the unread emails in accordance with their associated priority metric. The new email 156 from the second user 120 is then listed among the set of unread emails in accordance the average response time associated with the various email senders. As discussed in more detail below, the rank (i.e., position is the list) of the new email 156 from the second user 120 relative to the other unread emails is governed by the priority metric associated with the second sender relative to all the senders of the unread emails. The unread emails may be segregated into one of a plurality of folds associated with a plurality of different priority levels (FIGS. 3-4), or by graphical indicia, for example.

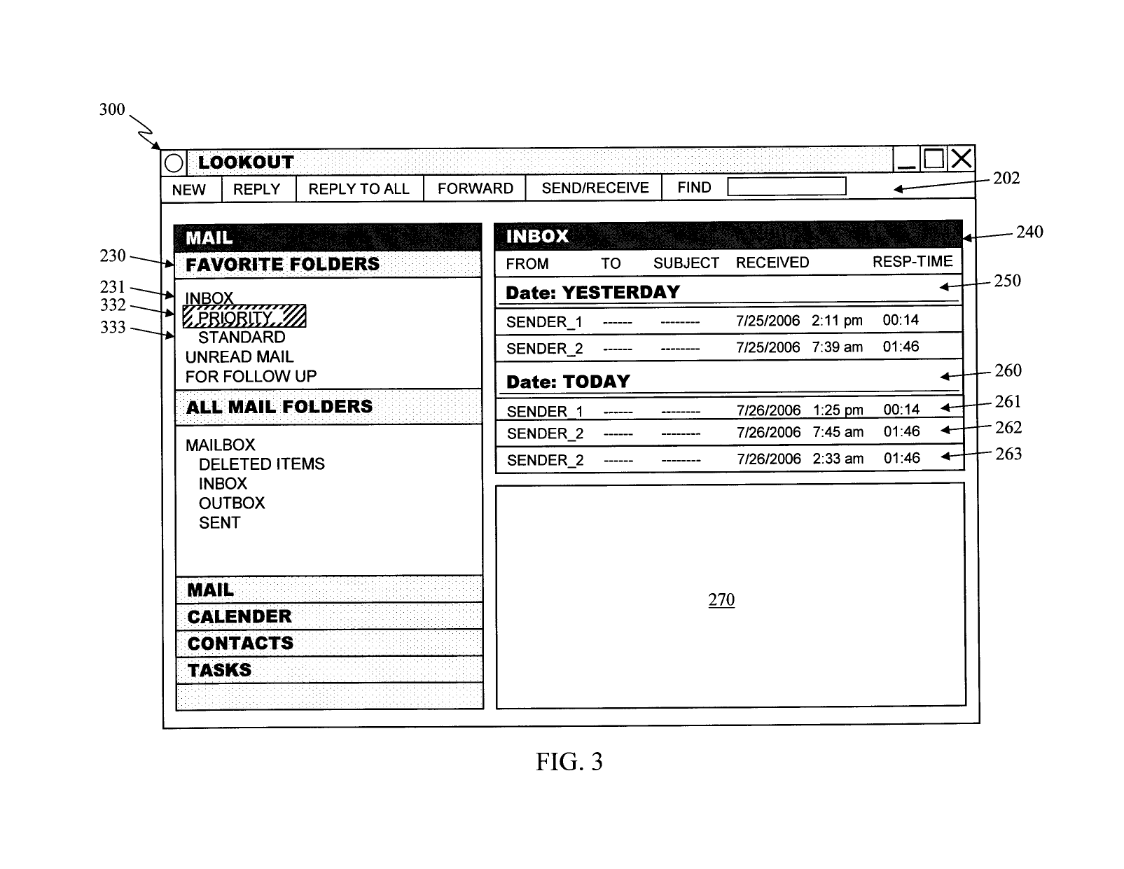

Illustrated in FIG. 2 is the mail user interface (UI) 200 of an email client program with which a user can view received emails and generate email responses. The mail UI 200 is selected with a pointing instrument, e.g., the click of a mouse, on the mail tab 210 of a function menu that also includes a calendar tab 211 for activating a calendaring tool; a contacts tab 212 for managing names, phone numbers, addresses, etc.; and a task tab 213 for managing a list of items to be done by the user.

Consistent with contemporary email clients, the mail UI 200 includes a button bar 202, one or more folder selection panes 220, 230, a folder viewing pane 240, and an email preview pane 270. The button bar 202 includes a plurality of buttons for creating a new email, replying to an email, replying to all parties to an email, forwarding an email, sending unsent emails and receiving unread emails, and searching or finding words present in a database of emails.

The mail UI 200 also maintains a plurality of mail folders into which various categories of emails are stored. These folders are accessible through one or more panes that include a list of folders. The various folder selection panes include an All Mail Folders 220 and Favorite Folders 230, either of which may be used to review the contents of a plurality of folders. Under the All Mail Folders 220, the user may select from a plurality of mailbox folders including, for example, a deleted Items folder 221, a draft email folder 222, an inbox folder 223, an outbox folder 224, and a sent mail folder 225. The inbox folder 223 may also be selected through the inbox folder 231 of the Favorite Folders 230 as well.

When the inbox folder 223 is highlighted, as shown, a partial list of received emails is shown in an inbox viewer pane 240 along with an optional preview of a selected email in preview pane 270. The list of received emails is generally set by default to show the most recent emails, e.g., emails received the current day 260 and one or more preceding days 250 if there is sufficient space. Referring to the list of emails received today 260, it can be seen that the user received emails from four different parties, namely sender_1, sender_2, sender_3 and sender_4. The identity of the sender is shown along side the recipient name, the email subject line, date and time the email was received, and preferably the average response time.

As described above, the response time represents the elapse time between receipt of the email and the mail response sent by the recipient, i.e., the first user 110. As illustrated in the list of emails received today 260, the user 110 responds to emails from sender_1 within 14 minutes on average, responds to emails from sender_2 within 1 hour 46 minutes on average, responds to emails from sender_3 within 17 hours 12 minutes on average, and responds to emails from sender_4 within 23 hours 42 minutes on average. When sorted based on response time, the emails are ordered from highest priority to lowest priority in the following order: first email 261 from sender_1 second email 262 and third email 263 from sender_2, fourth email 264 from sender_3, and fifth email 265 from sender_4.

As one skilled in the art will appreciate, today's 260 emails are not sorted in chronological order or reverse chronological order as is done in the prior art. Had they been sorted chronologically, the email would have been ordered: third email 263 received at 2:33 am, second email 262 received at 7:45 am, fourth email 264 received at 9:51 am, fifth email 265 received at 11:03 am, and first email 261 received at 1:25 pm.

In the preferred embodiment, the emails received today are sorted based on average response time or weighted-average response time. Depending on the embodiment, one or more preceding days are also sorted based on average response time consistent with today 260. Unless instructed by the user, however, the one or more preceding days may be sorted in chronological order as shown in the preceding day's inbox, i.e., yesterday 250.

Illustrated in FIG. 3 is a mail UI 300 of an email client program in accordance with a second exemplary embodiment. This embodiment assumes that the first user 110 has received the same five emails 261-265 shown in FIG. 2. In this embodiment, however, the Favorites Folder 230 includes one or more additional folders which, when selected, allow the user to view a redacted list of emails that had filtered based on the priority metric. In particular, the list of emails included in the inbox 240 is limited to those emails that match a priority threshold defined by the user, for example.

In this exemplary embodiment, the Favorite Folders 230 includes a priority folder 332 and standard folder 333. The priority folder 332 consists of emails that exceed the priority threshold while the standard folder 333 contains the remaining emails of lesser priority. Assuming a threshold equal to an average response time of five hours, for example, selection of the priority folder 332 (shown with highlight) limits the emails presented to those from the first and second user since their priorities (14 minutes and 1 hour 46 minutes, respectively) exceed the threshold. Redaction of the low priority emails may occur for today's 260 emails, one or more preceding days 250 as shown, or the entire inbox 240. The high-priority emails that are displayed may be sorted in accordance with their priority metric (as shown in FIG. 3) or chronologically.

Illustrated in FIG. 4 is a mail UI 400 of an email client program in accordance with the second embodiment. In contrast to FIG. 3, the inbox 240 consists of relatively low priority emails when the user selects the standard folder 333. As can be seen, the inbox 240 consists of emails from sender_3 and sender_4 whose associate priorities, i.e., the associated average response times (17 hours 12 minutes and 23 hours 42 minutes, respectively), fails to meet the priority threshold of five hours. Redaction of the high priority emails may occur for today's 260 emails, one or more preceding days 250 as shown, or the entire inbox 240. The low-priority emails that are displayed may be sorted in accordance with their priority metric (as shown in FIG. 4) or chronologically.

The average response time is based upon the difference in time between receipt of the email and associated user response. In the preferred embodiment, the time of receipt is the timestamp on the emails as shown in FIGS. 2-4. In other embodiments, however, the time of receipt of the email may be the time the email is made available to the reader by the ISP, the time that the user retrieves the email from the ISP, or the time the user reads the email.

In some situations, the user never responds to the email or, perhaps, never opens the email. This is sometimes true of emails from email subscriptions services including on-line news sources, for example. In these cases, the associated priority is automatically set to the lowest possible value and the email presented at the bottom of the standard priority folder 333.

In some cases, an email includes one or more email addresses in the “cc” field. Such an email may be sorted based on the sender's priority alone, or on a combination of priorities associated with the multiple recipients.

In another embodiment, shown in FIG. 5, the present invention provides an email management apparatus including a graphical user interface 500. In most cases this could be a display screen, emitting or reflecting electromagnetic radiation in the visible region (between about 400-700 nm). However, it may be desirable to rely on an audible interface (between about 20-20,000 Hz), as might be the case with a cellular phone or even a conventional computer system adapted for the sight impaired. The embodiment further includes an email response interval capture component 502. The response interval capture component 502 notes the interval of time (At) elapsing between the time that the email is received and the time a response is set. In another embodiment receipt can also be the time the email is opened. Opening emails out of sequence, that is skipping the first six emails in a queue to open the seventh may also be an indicia that the reader considers the seventh email to have a higher priority. The embodiment also includes an email response interval storage component 504. This component stores the time for the email response or other indicia of user perceived importance. At least one display priority metric component 506 uses collected user information and optionally external information (including specific features of the emails themselves) to prioritize the sequence. The email response interval capture component 502 is configured to capture the interval between the time an email is received and the time the received email is responded to. The email response interval storage component 504 stores the response interval and the at least one display priority metric component 506 correlates the intervals from the interval storage component 504 with certain characteristics of the email message. In the case of two or more display priority metrics, the correlation values may be combined in a weighted linear combination, for example, to generate a single display priority number or value associated with the email. As previously indicated, the email can be said to be received either when the email is opened, downloaded from a server, or other time. A plurality of received emails can then be sorted or re-sorted based on their respective display priorities.

One or more embodiments of the present invention may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including general purpose computers, special purpose computers, application-specific integrated circuit (ASIC), and digital/analog circuits with discrete components, for example.

Although the description above contains many specifications, these should not be construed as limiting the scope of the invention but as merely providing illustrations of some of the presently preferred embodiments of this invention.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other systems for exchanging electronic messages.

I claim:

1. An email management tool comprising:
a user interface with display area for displaying a list of received emails;
wherein a plurality of the received emails are sorted based upon priority metrics associated with the senders of the plurality of emails.

2. The email management tool of claim 1, wherein the priority metrics comprise average response times.

3. The email management tool of claim 2, wherein the average response times are based on the average time elapsed between receipt of one or more preceding emails and transmission of a response to the one or more preceding emails by the user.

4. An email management apparatus comprising:
a user interface;
an email response interval capture component configured to determine an interval between the time at least one email is received and the time the at least one received email is responded to;
an email response interval storage component configured to store the determined interval associated with the at least one email; and
a display priority metric component configured to:
correlate the determined interval with a one or more attributes of the at least one email; and
generate a priority number for each of a plurality of new emails based on the correlation between the determined interval and one or more email attributes of the at least one email;
wherein the plurality of new emails are displayed by the user interface in sequential order based on the generated priorities numbers.

5. The email management apparatus of claim 4, wherein the email is deemed to be received when the email is opened by the user.

6. The email management apparatus of claim 4, wherein the email is deemed to be received when the email is downloaded from a server.

7. The email management apparatus of claim 4, wherein the set of one or more characteristics includes at least two of the following:
name of email sender;
content of the email body;
time the email is sent;
content of email subject line; and
number of email recipients; and
sender defined indicia of urgency.

8. The email management apparatus of claim 4, wherein the set of one or more characteristics includes at least one of the following:
domain of the sender of the email;
sentence structure of the email;
punctuation in the email;
presence of misused words;
time the email is sent;
subject of the message;
number of recipients of the email; and
status of the recipient; and
sender defined indicia of urgency.

9. The email management apparatus of claim 4, wherein the at least one display priority metric component dynamically updates the display priority of a list of unread messages as new messages are received.

10. An email management method comprising the steps of:
determining a user response interval for a first plurality of emails;
generating an attribute priority number for one or more attributes associated with the first plurality of emails based on the determined response intervals; and
automatically ranking a second plurality of emails based on the attribute priority numbers associated with the first plurality of emails.

11. The email management method of claim 10, wherein the plurality of attributes associated with the first plurality of emails include at least two of the following:
name of email sender;
content of the email body;
time the email is sent;
content of email subject line; and
number of email recipients; and
sender defined indicia of urgency.

12. The email management method of claim 10 wherein the plurality of attributes associated with the first plurality of emails include at least one of the following:
domain of the sender of the email;
sentence structure of the email;
punctuation in the email;
presence of misused words;
time the email is sent;
subject of the message;
number of recipients of the email; and
status of the recipient; and
sender defined indicia of urgency.

13. The email management method of claim 10, wherein the attribute priority number for the plurality of attributes associated with the first plurality of emails are determined using maximum likelihood estimation.

14. The email management method of claim 12 wherein the sender defined indicia of urgency includes at least one of:
an email provided option allowing a user to specify urgency;
a term in the subject line indicating urgency; and
terms or expressions in the body which contextually indicate urgency.

15. The email management method of claim 10 wherein one or more of the attribute priority numbers is periodically updated.
